(19) United States
(12) Patent Application Publication
(10) Pub. No.: US 2026/0316662 A1
(43) Pub. Date: Oct. 15, 2026

(54) TENSIONING MACHINE

(71) Applicant: NINGBO XIHE MACHINERY CO., LTD., NINGBO (CN)

(72) Inventor: BO SHAO, NINGBO (CN)

(73) Assignee: NINGBO XIHE MACHINERY CO., LTD., NINGBO (CN)

(21) Appl. No.: 19/555,912

(22) Filed: Mar. 4, 2026

Related U.S. Application Data
(63) Continuation of application No. PCT/CN2025/088535, filed on Apr. 11, 2025.

(51) Int. Cl. B60P 7/08

(52) U.S. Cl. CPC B60P 7/083

(57) ABSTRACT

The present application relates to a tensioning machine, comprising: a bracket having an accommodating space for accommodating a binding belt; a spool, which is mounted on the bracket in a rotatable manner, runs through the accommodating space and is used for winding and reeling the binding belt; a volute spring, which is arranged on the spool and used for allowing the spool to tend to rotate in a direction of reeling the binding belt; a speed reduction assembly, which is arranged on the spool and used for acting on the spool to reduce the rotation speed of the spool when the spool rotates in the direction of reeling the binding belt; and, a blocking assembly, which is arranged on the bracket and used for selectively locking or releasing the rotation of the spool. The present tensioning machine, is significantly reducing the structural complexity.

### CROSS-REFERENCE OF THE RELATED APPLICATION

This application claims priority to China Patent Application No. 202510346358.8 filed Mar. 24, 2025, which is incorporated herein by reference in its entirety.

### TECHNICAL FIELD

The disclosure relates to the technical field of tensioners, and in particular to a tensioning machine.

### BACKGROUND

At present, most of the tensioning machines in the market are incapable of automatically reeling the binding belt, so operators have to take time to dispose the binding belt, resulting in the increase of operation burden and operation time. However, those tensioning machines with the belt reeling function often have the following technical problems. On one hand, the existing reeling devices cannot effectively control the reeling speed during reeling the binding belt, so that it is easy to reel the binding belt too fast; moreover, the reeling process cannot be stopped at will, so that the metal hook at the front end of the binding belt will rebound suddenly, resulting in potential safety hazards or even personal injury. On the other hand, the existing reeling mechanisms are often too complex in structure and inconvenient to use, thus increasing the operation difficulty and maintenance cost.

Although some existing solutions try to solve the binding belt reeling problem by additionally providing a reeling mechanism, only the implementation of the reeling function is usually considered without considering the layout design of the reeling mechanism itself, and the power element and the speed reduction element are directly arranged disorderly, thus increasing the structural complexity and effecting the whole operation efficiency and safety.

### SUMMARY

Embodiments of the present is to provide a tensioning machine to solve the problems mentioned in the BACKGROUND.

To solve the above problem, the present application provides a tensioning machine with more reasonable overall layout.

To achieve the above objective, the tensioning machine designed in the present application includes:
a bracket having an accommodating space for accommodating a binding belt;
a spool, which is mounted on the bracket in a rotatable manner, runs through the accommodating space and is used for winding and reeling the binding belt; a volute spring, which is arranged on the spool and used for allowing the spool to tend to rotate in a direction of reeling the binding belt;
a speed reduction assembly, which is arranged on the spool and used for acting on the spool to reduce the rotation speed of the spool when the spool rotates in the direction of reeling the binding belt; and
a blocking assembly, which is arranged on the bracket and used for selectively locking or releasing the rotation of the spool;
   wherein the spool has a first end exposed to the outside of the bracket and a second end arranged oppositely to the first end, the volute spring is arranged at the first end of the spool, and the speed reduction assembly is arranged at the second end of the spool.

Further, the speed reduction assembly is configured to act on the spool by friction.

Further, the speed reduction assembly includes a mounting shaft, a speed reduction plate and a first torsion spring that is sheathed on the mounting shaft and acts on the speed reduction plate; the speed reduction plate is pivoted to the mounting shaft and has a first position; and, at the first position, the speed reduction plate abuts against an outer circumferential surface of the second end of the spool under the action of the first torsion spring.

Further, two lugs arranged oppositely are provided on the speed reduction plate, the two lugs are sheathed on the mounting shaft at intervals, and the first torsion spring is located between the two lugs.

Further, knurls for increasing friction are provided on the second end of the spool; or, a gear is sheathed on the second end of the spool, and tooth tips of the gear come into contact with the surface of the speed reduction plate away from the first torsion spring.

Further, the speed reduction plate has a second position where it does not act on the spool, and an operating handle configured to drive the speed reduction plate to switch from the first position to the second position is provided on the speed reduction plate.

Further, an evading hole is formed on a sidewall of the bracket, the speed reduction plate has a first pressing portion extending into the accommodating space through the evading hole, and an operating window exposing the first pressing portion and the accommodating space is provided on the top of the bracket.

Further, the tensioning machine further includes a protective shell which is fixedly mounted on the sidewall of the bracket and covers the speed reduction assembly; and, one end of the first torsion spring is resisted against the upper surface of the speed reduction plate, while the other end thereof is resisted against an inner wall of the protective shell.

Further, the blocking assembly includes:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
   wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

Further, the second check plate has a limiting bump protruded from the bracket, and a guide groove for limiting the movement range of the limiting bump is provided on the sidewall of the bracket.

In the tensioning machine designed in the present application, under the premise of ensuring structural compactness, the volute spring and the speed reduction assembly are separately arranged at both ends of the spool, thus realizing more reasonable overall layout, effectively reducing the mutual interference between components and significantly reducing the structural complexity. Specifically, a driving force for rotation in the direction of reeling the binding belt is provided to the spool by the volute spring provides the spool, thus realizing the automatic reeling of the binding belt and effectively eliminating tedious manual operation. Moreover, the speed reduction assembly acts on the spool by friction, so that the rotation speed of the spool can be effectively reduced, the potential safety hazards caused by too fast reeling of the woven belt can be avoided, and the reliability and service life of the device can be improved.

### BRIEF DESCRIPTION OF THE DRAWINGS

The above and/or additional aspects and advantages of the present disclosure would become apparent and easily understood from the following description of the embodiments in combination with the drawings, in which:

FIG. 1 is a schematic structure diagram of the tensioning machine according to an embodiment of the present application;

FIG. 2 is a schematic structure diagram of the speed reduction assembly according to an embodiment of the present application;

FIG. 3 is a stereoscopically exploded view of FIG. 1;

FIG. 4 is a top view of FIG. 1; and

FIG. 5 is a sectional view of FIG. 4 along A-A;

in which: 10: bracket; 11: evading hole; 12: guide groove; 20: spool; 21: gear; 30: volute spring; 40: speed reduction assembly; 41: mounting shaft; 42: speed reduction plate; 421: lug; 422: operating handle; 423: first pressing portion; 43: first torsion spring; 44: protective shell; 50: blocking assembly; 51: ratchet wheel; 52: reel; 53: eccentric wheel; 54: handle; 55: first check plate; 56: compression spring; 57: second check plate; 571: second pressing portion; 572: limiting bump; 58: second torsion spring; and, 60: operating window.

The disclosure will be further described by the following specific embodiments in combination with the accompanying drawings.

### DETAILED DESCRIPTION OF PREFERRED EMBODIMENTS

The preferred embodiments of the will be illustrated below with reference to the drawings. It should be understood that the preferred embodiments described herein are merely used for illustrating and explaining the embodiment of the present, rather than limiting the present.

### Embodiment 1

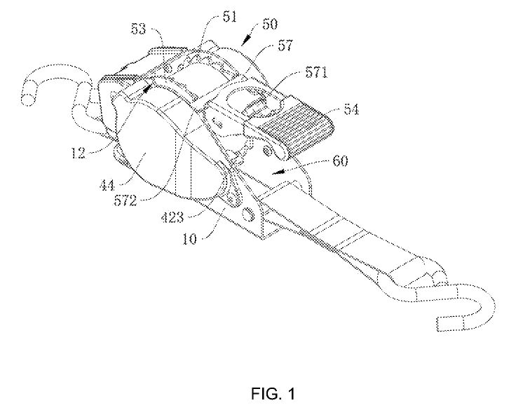

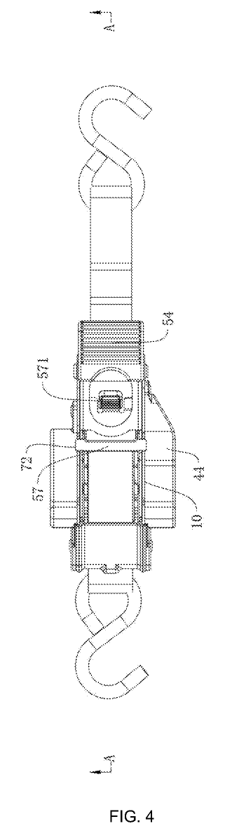

As shown in FIGS. 1-5, the tensioning machine described in this embodiment mainly includes a bracket 10, a spool 20, a volute spring 30, a speed reduction assembly 40 and a blocking assembly 50. These components jointly realize the automatic reeling of the binding belt, the speed control and the selective locking through structural design and cooperation.

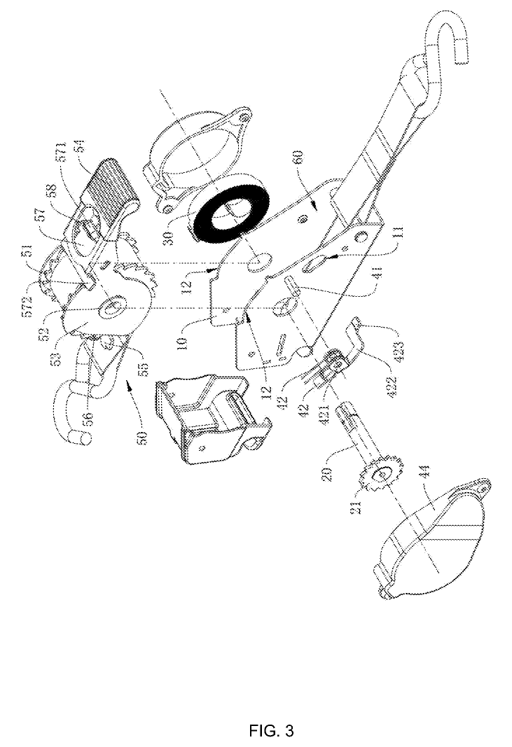

The bracket 10 has an accommodating space for accommodating a binding belt. During a specific implementation, the bracket 10 is preferably made from high-strength steel by impact molding, so that the U-shaped structure shown in FIG. 3 is formed. The side plates on both sides provide the basis for mounting the remaining components, so that the strength and rigidity of the overall structure are ensured, the internal space suitable for accommodating the binding belt is formed, and it is convenient for the orderly storage of the binding belt.

The spool 20 is mounted on the bracket 10 in a rotatable manner and runs through the accommodating space, and is used for winding and reeling the binding belt. The spool 20 is cylindrical, and anti-slip ridges can be provided on the surface of the spool 20 to increase the friction between the spool 20 and the binding belt, thus ensuring that the binding belt will not get loose or slide in the reeling process. Thus, when the spool 20 rotates in the predetermined direction, the binding belt can be smoothly wound and reeled.

The volute spring 30 is arranged on the spool 20 and used for allowing the spool 20 to tend to rotate in the direction of reeling the binding belt. A certain torque is preloaded on the volute spring 30 during mounting, so that the spool 20 is endowed with a continuous tendency of rotating in the direction of reeling the binding belt. After the external force is released, the volute spring 30 can automatically drive the spool 20 to rotate, thus realizing the automatic reeling of the binding belt without manual intervention.

The speed reduction assembly 40 is arranged on the spool 20 and used for acting on the spool 20 to reduce the rotation speed of the spool 20 when the spool 20 rotates in the direction of reeling the binding belt. In this embodiment, the speed reduction assembly 40 acts on the spool 20 by friction to produce the appropriate damping effect. This design effectively avoids the impact, noise and potential safety hazards possibly produced by fast reeling of the binding belt, so that the whole reeling process is smoother and more controllable.

The blocking assembly 50 is arranged on the bracket 10 and used for selectively locking or releasing the rotation of the spool 20.By operating the blocking assembly 50, the user can control the start and stop of the reeling process at any time according to actual needs, thus further improving the flexibility and safety of operation. The specific structure and operation principle of the blocking assembly 50 will be described in detail later in this embodiment.

The spool 20 has a first end exposed to the outside of the bracket 10 and a second end arranged oppositely to the first end. The volute spring 30 is arranged at the first end of the spool 20, and the speed reduction assembly 40 is arranged at the second end of the spool 20. This structural design in which the reeling power source (the volute spring 30) and the resistance control mechanism (the speed reduction assembly 40) are separately arranged at both ends of the pool 20 significantly optimizes the overall structural layout. By separately arranging the component that produces the rotation tendency and the component that controls the rotation speed, the mutual interference between the two components is effectively avoided, their respective functions are realized more purely, and the overall stability and reliability of the system are improved. Moreover, this layout is also convenient for the mounting, overhauling and maintenance of the components, and the service life of the device is prolonged.

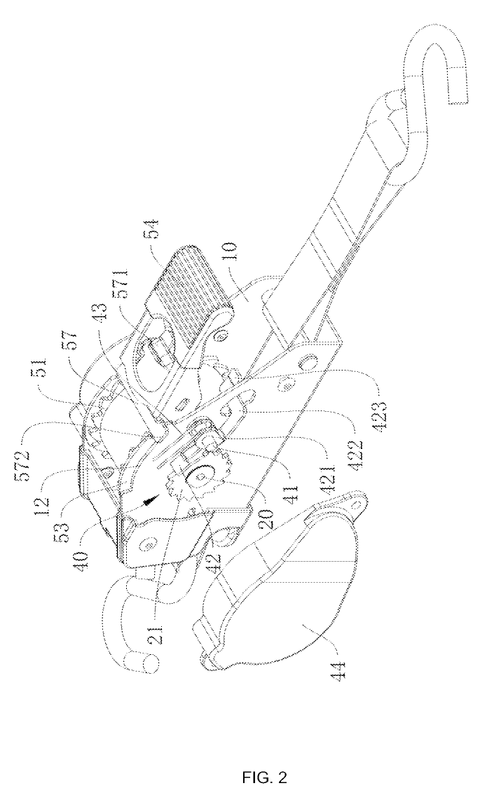

In some embodiments, as shown in FIGS. 2 and 3, the speed reduction assembly 40 includes a mounting shaft 41, a speed reduction plate 42 and a first torsion spring 43 that is sheathed on the mounting shaft 41 and acts on the speed reduction plate 42. The speed reduction plate 42 is pivoted to the mounting shaft 41 and has a first position. At the first position, the speed reduction plate 42 abuts against an outer circumferential surface of the second end of the spool 20 under the action of the first torsion spring 43.When the spool 20 rotates in the direction of reeling the binding belt under the drive of the volute spring 30, the speed reduction plate 42 at the first position is subjected to the force of the first torsion spring 43 and produces friction with the outer circumferential surface of the second end of the spool 20, thus effectively preventing the fast rotation of the spool 20 and achieving the purpose of reducing the rotation speed. Thus, the binding belt can be smoothly reeled, and the potential safety hazards possibly caused by fast bounce can be avoided. To improve the friction effect, in this embodiment, the contact surfaces of the speed reduction plate 42 and the spool 20 are designed to be arc-shaped. The arc-shaped surface may be circular arc surfaces, parabolic surfaces, or curved surfaces formed by splicing a plurality of planes, to increase the contact area with the spool 20 and improve the speed reduction efficiency.

During a specific implementation, as shown in FIGS. 2 and 3, two lugs 421 arranged oppositely are provided on the speed reduction plate 42, and the two lugs 421 are sheathed on the mounting shaft 41 at intervals. By sheathing the two lugs 421 arranged at intervals on the mounting shaft 41, more stable and reliable pivoted support can be provided, the shaking or inclination of the speed reduction plate 42 in the swinging process is reduced, and the more uniform and stable contact with the spool 20 is ensured. The first torsion spring 43 is located between the two lugs 421, so that the overall structure of the speed reduction assembly 40 is more compact, and the space occupied is reduced.

In some embodiments, a knurl for increasing friction is provided on the spool 20. The knurl is a fine and dense mesh formed on the surface of the spool 20, so that the friction coefficient of the contact surface can be increased, a larger frictional resistance can be obtained on the speed reduction assembly 40 when abutting against the spool 20, and a more effective speed reduction effect is achieved. In another specific embodiment, as shown in FIGS. 2 and 3, a gear 21 is sheathed on the second end of the spool 20, and tooth tips of the gear 21 come into contact with the surface of the speed reduction plate 42 away from the first torsion spring 43. The gear 21 is generally made of high-strength steel and has excellent wear resistance. By making the tooth tips of the gear 21 come into contact with the speed reduction plate 42, the direct wear on the surface of the spool 20 is reduced. Moreover, as an independent component, the gear 21 can be conveniently replaced in the case of serious wear, thus reducing the maintenance cost.

In some embodiments, as shown in FIGS. 2 and 3, the speed reduction plate 42 has a second position where it does not act on the spool 20, and an operating handle 422 is provided on the speed reduction plate 42. The operating handle 422 is configured such that an external force can be applied to the operating handle 422 by an operator to drive the speed reduction plate 42 to from the first position where it comes into contact with the spool 20 to the second position where it does not come into contact with the spool 20 or the contact is weakened. In normal circumstances, under the action of the first torsion spring 43, the speed reduction plate 42 is kept at the first position and closely abuts against the outer circumferential surface of the second end of the spool 20, result in frictional resistance and limiting the reeling speed. However, in the actual operation process, it may be necessary to quicken the reeling speed or completely release the speed reduction effect sometimes. At this time, the operator can overcome the force of the first torsion spring 43 by pressing or poking the operating handle 422, to drive the speed reduction plate 42 to pivot around the mounting shaft 42, so that the speed reduction plate 42 moves to the second position. At the second position, the friction between the speed reduction plate 42 and the spool 20 is significantly reduced, or even the speed reduction plate 42 is completely out of contact with the spool 20, so that the spool 20 is allowed to reel the binding belt at a higher speed under the drive of the volute spring 30.For example, at the beginning of reeling, the binding belt may be loose. At this time, the operator can press the operating handle 422 to locate the speed reduction plate 42 at the second position, quicken the initial reeling speed and shorten the operation time. When the binding belt is gradually tensioned, the operator can release the operating handle 422 to return the speed reduction plate 42 to the first position under the action of the first torsion spring 43, so as to limit the reeling speed again and prevent too fast reeling.

In some embodiments, as shown in FIGS. 2 and 3, an evading hole 11 is formed on a sidewall of the bracket 10, the speed reduction plate 42 has a first pressing portion 423 extending into the accommodating space through the evading hole 11, and an operating window 60 exposing the first pressing portion 423 and the accommodating space is provided on the top of the bracket 10.By using this structural design, the operating end of the operating handle 422 (i.e., the first pressing portion 423) can be accommodated inside the accommodating space of the bracket 10, and the operator can still conveniently press the first pressing portion 423 through the operating window 60 formed on the top of the bracket 10, thus effectively avoiding the direct impact on the first pressing portion 423 from external environmental factors (e.g., accident squeezing or collision in the binding or transportation process), significantly improving the reliability and durability of the speed reduction control mechanism and reducing the risk of speed reduction failure caused by unintended touch or external force.

In some embodiments, as shown in FIGS. 2 and 3, the tensioning machine further includes a protective shell 44 which is fixedly mounted on the sidewall of the bracket 10 and covers the speed reduction assembly 40; and, one end of the first torsion spring 43 is resisted against the upper surface of the speed reduction plate 42, while the other end thereof is resisted against an inner wall of the protective shell 44. The protective shell 44 can effectively cover the key components (e.g., the mounting shaft 41, the speed reduction plate 42, the first torsion spring 43, etc.) of the speed reduction assembly 40 completely, thus preventing external dust, sundries, moisture and the like from entering the speed reduction assembly, avoiding speed reduction failure or performance degradation caused by foreign matter interference, and significantly improving the reliability and durability of the speed reduction assembly. In another example, similar to the speed reduction assembly, a volute casing for accommodating the volute spring 30 is also provided on the side where the volute spring 30 is arranged, to protect the volute spring 30.

In some embodiments, as shown in FIGS. 1-5, the blocking assembly 50 includes:
a reel 52 with ratchet wheels 51 at its two ends, which is mounted on the spool 20 in a rotatable manner;
a handle 54 with an eccentric wheel 53, the handle 54 being mounted on the spool 20 in a rotatable manner through the eccentric wheel 53;
a first check plate 55, which is arranged on the bracket 10, acts on the ratchet wheels 51 through a compression spring 56, and is used for preventing the reel 52 from rotating in a direction opposite to the direction of reeling the binding belt; and
a second check plate 57, which is arranged on the handle 54, acts on the ratchet wheels 51 through a second torsion spring 58, and is used for preventing the reel 52 from rotating in a direction opposite to the direction of reeling the binding belt.

The handle 54 is configured to drive the eccentric wheel 53 to rotate in the direction of reeling the binding belt under the action of an external force, so as to drive the first check plate 55 to switch from a position where it acts on the ratchet wheels 51 to a position where it does not act on the ratchet wheels 51, and a second pressing portion 571 for controlling the second check plate 57 to switch from a position where it acts on the ratchet wheels 51 to a position where it does not act on the ratchet wheels 51 is provided on the second check plate 57.

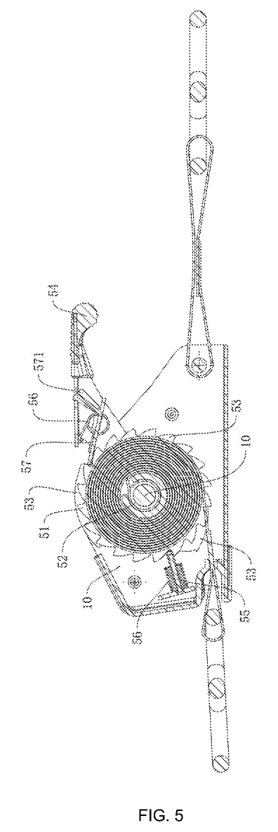

In the actual operation process, as shown in FIG. 5:

During normal operation, the rear end of the bracket 10 and the binding belt reeled on the reel 52 are hooked at the target positions through the hooks on the front and rear sides of the bracket 10. At this time, the first check plate 55 is meshed with the ratchet teeth of the ratchet wheels 51 under the action of the compression spring 56, and the second check plate 58 is meshed with the ratchet teeth of the ratchet wheels 51 under the action of the second torsion spring 58, so that the reel 52 is prevented from rotating in the direction opposite to the direction of reeling the binding belt (clockwise), and it is ensured that the cargo will not be displaced during transportation due to loose binding belt.

When it is necessary for further tensioning to tie the cargo, the handle 54 is rotated to allow the eccentric wheel 53 to rotate in the direction of reeling the binding belt (counterclockwise), and the rotation of the eccentric wheel 53 will push the first check plate 55 to compress the compression spring 56 until the first check plate 55 is separated from the ratchet teeth of the ratchet wheels 51. Meanwhile, the second check plate 57 arranged on the rotating handle 54 is kept to mesh with the ratchet wheels 51 to drive the ratchet wheels 51 and the reel 52 to rotate counterclockwise, thus realizing the contraction of the binding belt. By repeatedly rotating the handle 54, the binding belt can be gradually tensioned until the cargo is firmly bound.

When it is necessary to loosen the cargo, the second pressing portion 571 is pressed to switch the second check plate 57 from a position where it acts on the ratchet wheels 51 to a position where it does not act on the ratchet wheels 51, that is, the second check plate 57 is separated from the ratchet teeth of the ratchet wheels 51. At this time, by rotating the handle 54, the eccentric wheel 53 is allowed to rotate counterclockwise to push the first check plate 55 to compress the compression spring 56 until the first check plate 55 is separated from the ratchet teeth of the ratchet wheels 51. At this time, the ratchet wheels 51 and the reel 52 can rotate clockwise or counterclockwise without limitation, and the operator can directly move the bracket 10 and pull the binding belt to loosen the binding belt to the required length, so that it is convenient to loosen the cargo.

In some embodiments, as shown in FIGS. 2 and 3, the second check plate 57 has a limiting bump 572 protruded from the bracket 10, and a guide groove 12 for limiting the movement range of the limiting bump 572 is provided on the sidewall of the bracket 10.By limiting by the guide groove 12, the rotation angle of the second check plate 57 (i.e., the rotation angle of the handle 54) is limited within the expected range, avoiding the damage possibly caused by excessive rotation.

In the tensioning machine designed in the present application, under the premise of ensuring structural compactness, the volute spring and the speed reduction assembly are separately arranged at both ends of the spool, thus realizing more reasonable overall layout, effectively reducing the mutual interference between components and significantly reducing the structural complexity. Specifically, a driving force for rotation in the direction of reeling the binding belt is provided to the spool by the volute spring provides the spool, thus realizing the automatic reeling of the binding belt and effectively eliminating tedious manual operation. Moreover, the speed reduction assembly acts on the spool by friction, so that the rotation speed of the spool can be effectively reduced, the potential safety hazards caused by too fast reeling of the woven belt can be avoided, and the reliability and service life of the device can be improved.

In the description of the present application, it should be noted that the orientation or position relation indicated by terms "vertical", "upper", "lower", "horizontal" or the like is an orientation or position relation shown based on the drawings, merely for describing the present application and simplifying the description rather than indicating or implying that the specified device or element must have a particular orientation or be constructed and operated in a particular orientation. Therefore, the terms should not be interpreted as limitations to the present application.

In the description of the present application, it should also be noted that, unless otherwise expressly specified and defined, the terms "arrange", "mount", "link" and "connect" should be interpreted in a broad sense. For example, the connection may be fixed connection, detachable connection or integral connection; or, may be mechanical connection or electrical connection; or, may be direct connection or indirect connection through an intermediate medium; or, may be internal communication between two elements. A person of ordinary skill in the art can interpret the specific meanings of the terms in the present application according to specific situations.

It should be finally noted that, the above description only shows the preferred embodiments of the present application and is not intended to limit the present application. Although the present application has been described in detail with reference to the above embodiments, those skilled in the art can still modify the technical solutions recorded in the above embodiments or make equivalent replacements to some technical features. Any modifications, equivalent replacements and improvements made without departing from the spirit and principle of the present application shall fall into the protection scope of the present application.

What is claimed is:

1. A tensioning machine, comprising:
a bracket having an accommodating space for accommodating a binding belt;
a spool, which is mounted on the bracket in a rotatable manner, runs through the accommodating space and is used for winding and reeling the binding belt; a volute spring, which is arranged on the spool and used for allowing the spool to tend to rotate in a direction of reeling the binding belt;
a speed reduction assembly, which is arranged on the spool and used for acting on the spool to reduce the rotation speed of the spool when the spool rotates in the direction of reeling the binding belt; and
a blocking assembly, which is arranged on the bracket and used for selectively locking or releasing the rotation of the spool;
wherein the spool has a first end exposed to the outside of the bracket and a second end arranged oppositely to the first end, the volute spring is arranged at the first end of the spool, and the speed reduction assembly is arranged at the second end of the spool.

2. The tensioning machine according to claim 1, wherein the speed reduction assembly is configured to act on the spool by friction.

3. The tensioning machine according to claim 1, wherein the speed reduction assembly comprises a mounting shaft, a speed reduction plate and a first torsion spring that is sheathed on the mounting shaft and acts on the speed reduction plate; the speed reduction plate is pivoted to the mounting shaft and has a first position; and, at the first position, the speed reduction plate abuts against an outer circumferential surface of the second end of the spool under the action of the first torsion spring.

4. The tensioning machine according to claim 3, wherein two lugs arranged oppositely are provided on the speed reduction plate, the two lugs are sheathed on the mounting shaft at intervals, and the first torsion spring is located between the two lugs.

5. The tensioning machine according to claim 4, wherein knurls for increasing friction are provided on the second end of the spool; or, a gear is sheathed on the second end of the spool, and tooth tips of the gear come into contact with the surface of the speed reduction plate away from the first torsion spring.

6. The tensioning machine according to claim 4, wherein the speed reduction plate has a second position where it does not act on the spool, and an operating handle configured to drive the speed reduction plate to switch from the first position to the second position is provided on the speed reduction plate.

7. The tensioning machine according to claim 6, wherein an evading hole is formed on a sidewall of the bracket, the speed reduction plate has a first pressing portion extending into the accommodating space through the evading hole, and an operating window exposing the first pressing portion and the accommodating space is provided on the top of the bracket.

8. The tensioning machine according to claim 3, further comprising a protective shell which is fixedly mounted on the sidewall of the bracket and covers the speed reduction assembly, one end of the first torsion spring being resisted against the upper surface of the speed reduction plate while the other end thereof being resisted against an inner wall of the protective shell.

9. The tensioning machine according to claims claim 1, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

10. The tensioning machine according to claims claim 2, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

11. The tensioning machine according to claims claim 3, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

12. The tensioning machine according to claims claim 4, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

13. The tensioning machine according to claims claim 5, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

14. The tensioning machine according to claims claim 6, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

15. The tensioning machine according to claims claim 7, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

16. The tensioning machine according to claims claim 8, wherein the blocking assembly comprises:
a reel with ratchet wheels at its two ends, which is mounted on the spool in a rotatable manner;
a handle with an eccentric wheel, the handle being mounted on the spool in a rotatable manner through the eccentric wheel;
a first check plate, which is arranged on the bracket, acts on the ratchet wheels through a compression spring, and is used for preventing the reel from rotating in a direction opposite to the direction of reeling the binding belt; and
a second check plate, which is arranged on the handle, acts on the ratchet wheels through a second torsion spring, and is used for preventing the reel from rotating in a direction opposite to the direction of reeling the binding belt;
wherein the handle is configured to drive the eccentric wheel to rotate in the direction of reeling the binding belt under the action of an external force, so as to drive the first check plate to switch from a position where it acts on the ratchet wheels to a position where it does not act on the ratchet wheels, and a second pressing portion for controlling the second check plate to switch from a position where it acts on the ratchet wheels to a position where it does not act on the ratchet wheels is provided on the second check plate.

17. The tensioning machine according to claim 9, wherein the second check plate has a limiting bump protruded from the bracket, and a guide groove for limiting the movement range of the limiting bump is provided on the sidewall of the bracket.
